(19) United States
(12) Patent Application Publication
(10) Pub. No.: US 2012/0110566 A1
(43) Pub. Date: May 3, 2012

(54) APPARATUS AND METHOD FOR SETTING UP MULTI-TENANT SAAS APPLICATIONS

(75) Inventor: Kyoung-Hyun PARK, Daejeon (KR)

(73) Assignee: Electronics and Telecommunications Research Institute, Daejeon-city (KR)

(21) Appl. No.: 13/284,185

(22) Filed: Oct. 28, 2011

(30) Foreign Application Priority Data
Oct. 29, 2010 (KR) 10-2010-0107210

(51) Int. Cl. G06F 9/445

(52) U.S. Cl. 717/174

(57) ABSTRACT

Disclosed herein is an apparatus and method for setting up multi-tenant. SaaS applications, which convert setup information for SaaS applications into metadata, manage the metadata, and dynamically generate and provide a relevant service based on the metadata at the request of a user. The apparatus for setting up multi-tenant SaaS applications includes an environment setup unit for receiving setup information required to set up service environments of SaaS applications and converting the setup information into metadata. A setup information management unit manages setup information for SaaS applications for respective tenants using the metadata converted by the environment setup unit. A service provision unit provides SaaS applications that have been set up in different environments for the respective tenants using the metadata managed by the setup information management unit.

### CROSS REFERENCE TO RELATED APPLICATION

This application claims the benefit of Korean Patent Application No. 10-2010-0107210, filed on Oct. 29, 2010, which is hereby incorporated by reference in its entirety into this application.

### BACKGROUND OF THE INVENTION

1. Technical Field

The present invention relates generally to Software as a Service (SaaS) applications and, more particularly, to an apparatus and method for setting up multi-tenant SaaS applications, which provide the function of setting up independent SaaS applications for respective tenants so as to enable multi-tenant support.

2. Description of the Related Art

Existing web applications are based on a client-server service model and implemented in such a way as to provide the same service to multiple clients in one instance. That is, typical software binds functions required for clients and provides the same bound function to all clients. However, in such software, a large number of functions that are not very necessary for some clients are installed, and thus clients must pay even for unnecessary functions.

However, as time passes, the requirements of the client side have become diversified, and it has become impossible for existing web applications to completely reflect all the requirements of a large number of clients.

Therefore, Software as a Service (SaaS) that allows individual persons to use only the functions that they actually need and to pay for those functions was developed. SaaS is a service distribution model configured such that software providers provide tenants with software in the form of a service via the web. That is, SaaS is a service for configuring applications implemented using only functions required by clients among software functions and providing the configured applications to the clients. Clients who use SaaS can exploit only necessary functions as needed, and pay only for functions that were used by the clients.

SaaS is classified into a type in which a client downloads required functions and installs the functions on the client's terminal, and a type in which the functions of software that are running on a server are used online over a network.

However, software providers have encountered a plurality of technical issues, such as a data security problem and the problem of setting up independent services for respective tenants, when developing and providing SaaS. However, due to the insufficiency of technology required to solve these technical issues, SaaS has not yet become active in software markets. For example, one of the principal features of SaaS is to enable multi-tenant support for servicing multiple tenants based on a single application instance and to provide the function of setting up independent SaaS applications for respective tenants.

In order to provide this service, it is impossible for existing application structures to be used, and thereby metadata-based system architecture (a metadata-driven architecture) must be designed. Some front-running software developers are developing SaaS platforms and applications to support SaaS, but they do not yet have SaaS technology complete enough to fully support both such a multi-tenant function and an application setup function.

### SUMMARY OF THE INVENTION

Accordingly, the present invention has been made keeping in mind the above problems occurring in the prior art, and an object of the present invention is to provide an apparatus and method for setting up multi-tenant SaaS applications, which convert setup information for SaaS applications into metadata and manage the metadata, and which dynamically generate and provide relevant services based on the metadata at the request of a user.

In accordance with an aspect of the present invention to accomplish the above object, there is provided an apparatus for setting up multi-tenant Software as a Service (SaaS) applications, including an environment setup unit for receiving setup information required to set up service environments of SaaS applications and converting the setup information into metadata; a setup information management unit for managing setup information of SaaS applications for respective tenants using the metadata converted by the environment setup unit; and a service provision unit for providing SaaS applications that have been set up in different environments for the respective tenants using the metadata.

Preferably, the environment setup unit may include an input unit for receiving the setup information required to set up the environments of the SaaS applications; and a conversion unit for converting the setup information into the metadata.

Preferably, the environment setup unit may convert the setup information into a tree model, detect only data corresponding to characteristics of a relevant tenant from the tree model, and then convert the setup information into the metadata.

Preferably, the setup information management unit may manage the metadata converted by the environment setup unit so that the metadata is associated with relevant tenants.

Preferably, the apparatus may further include a setup information storage unit for storing setup information of a plurality of tenants.

Preferably, the setup information storage unit may store tenant information and the metadata so that the tenant information is associated with the metadata.

In accordance with another aspect of the present invention to accomplish the above object, there is provided an apparatus for setting up multi-tenant Software as a Service (SaaS) applications, including a page setup unit for converting setup information that is input to set up user interfaces for respective tenants of SaaS applications into metadata; a database (DB) for storing the metadata converted by the page setup unit so that the metadata is associated with information about relevant tenants; and a User Interface (UI) rendering unit for dynamically generating an SaaS application using metadata for a tenant detected from the DB, and providing the SaaS application to a user of the tenant.

Preferably, the page setup unit may receive the setup information required to set up the user interfaces by a UI component unit.

Preferably, the page setup unit may convert the setup information into a tree model, manage the tree model, and if setup of the user interfaces has been completed, convert the tree model into metadata and store the metadata in the DB.

Preferably, the page setup unit may detect only data corresponding to characteristics of a relevant tenant from the tree model, and then convert the setup information into the metadata.

Preferably, the DB may further store at least one of data schema information, code information, and script information which are used by each SaaS application.

Preferably, the apparatus may further include a schema management unit for managing, for respective tenants, schema information required to set up data schema used by SaaS applications.

Preferably, the schema management unit may link a UI component used by the SaaS application to a table of the DB.

Preferably, the apparatus may further include a code management unit for managing a plurality of code used by the SaaS application that is provided to the tenant user.

Preferably, the apparatus may further include a script management unit for managing script information that includes at least one of a data validity check and a rendering script of SaaS application provided in a form of a web page.

Preferably, the apparatus may further include a domain management unit for managing script-type domain information and code-type domain information.

In accordance with a further aspect of the present invention to accomplish the above object, there is provided a method for setting up multi-tenant Software as a Service (SaaS) applications, including setting setup information including at least one of environment information, required to set up environments of SaaS applications for respective tenants, and data schema of the SaaS applications; converting the setup information of the SaaS applications for respective tenants into metadata; managing the metadata so that the metadata is associated with information about relevant tenants; and providing a tenant user with an SaaS application that is generated using metadata for a tenant, for which use of an SaaS application has been requested, in the metadata.

Preferably, the converting may include converting the setup information into a tree model; and converting the tree model into the metadata.

Preferably, the converting into the metadata may be configured to detect only data corresponding to characteristics of a relevant tenant from the tree model and then convert the setup information into the metadata.

Preferably, the method may further include setting up data schema used by SaaS applications for respective tenants.

According to the present invention, the following advantages can be converted compared to SaaS provided by conventional web applications.

First, the present invention is advantageous in that setup information for SaaS applications is converted into metadata and the metadata is managed and in that when there is a request from a tenant, a relevant service is dynamically generated and provided based on the metadata, thus enabling independent applications to be set for respective tenants.

Further, in the present invention, a tenant that uses SaaS application service can reflect business requirements in applications in conformity with the situation of the tenant without re-executing the service. That is, a user interface and a data schema can be set in accordance with the environment of the tenant. Accordingly, the present invention facilitates both helping the service provided by the SaaS application to be optimized for the environment of the tenant and setting up the service, thus obtaining the effect of reducing costs required by tenants to use the service.

Furthermore, in the present invention, since services are generated and provided based on metadata, independent service environments can be provided to the respective tenants. This allows SaaS application vendors to considerably reduce maintenance costs. Existing web applications are problematic in that when updating the service, all applications that provide the service must be updated. However, SaaS applications are advantageous in that since the service is independently provided to all tenants by one instance, all tenants can be provided with updated service using a single update operation, and tenant-independent service environments can be equally used similarly to the conventional technology.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the construction of an apparatus for setting up multi-tenant SaaS applications according to a first embodiment of the present invention;

FIG. 2 is a block diagram showing the construction of the environment setup unit of FIG. 1;

FIG. 3 is a flowchart showing a method of setting up multi-tenant SaaS applications according to a first embodiment of the present invention;

FIG. 4 is a block diagram showing the construction of an apparatus for setting up multi-tenant SaaS applications according to a second embodiment of the present invention;

FIG. 5 is a block diagram showing the construction of the database of FIG. 4;

FIG. 6 is a flowchart showing a method of setting up the environments of SaaS applications using page setup according to a second embodiment of the present invention; and

FIG. 7 is a flowchart showing a method of setting up the environments of SaaS applications using schema setup according to the second embodiment of the present invention.

### DESCRIPTION OF THE PREFERRED EMBODIMENTS

Hereinafter, preferred embodiments of the present invention will be described in detail with reference to the attached drawings so as to describe the present invention in detail to such an extent that those skilled in the art to which the present invention pertains can easily implement the technical spirit of the present invention. Reference now should be made to the drawings, in which the same reference numerals are used throughout the different drawings to designate the same or similar components. Further, if in the specification, detailed descriptions of well-known functions or configurations may unnecessarily make the gist of the present invention obscure, the detailed descriptions will be omitted.

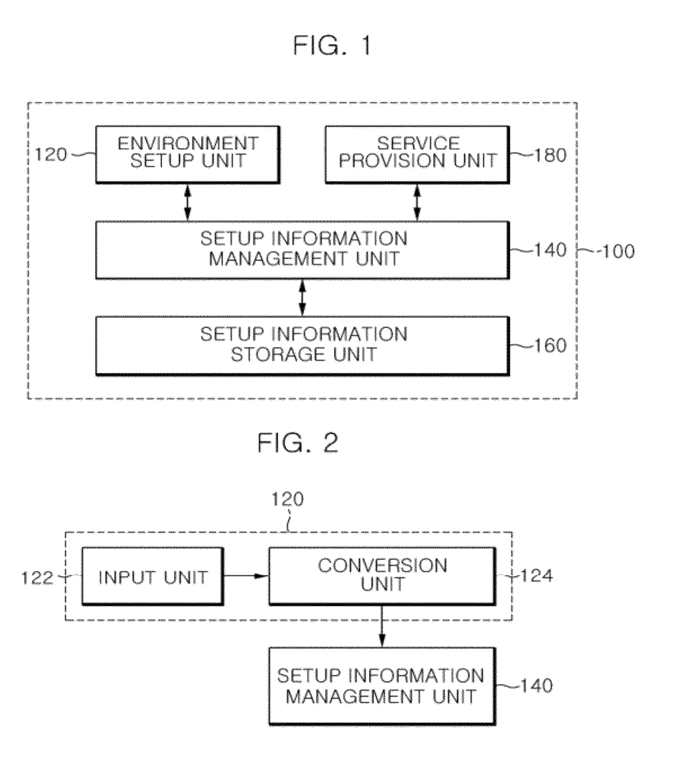

Hereinafter, an apparatus for setting up multi-tenant SaaS applications according to a first embodiment of the present invention will be described in detail with reference to the attached drawings. FIG. 1 is a block diagram showing the construction of an apparatus for setting up multi-tenant SaaS applications according to a first embodiment of the present invention, and FIG. 2 is a block diagram showing the construction of the environment setup unit of FIG. 1.

The apparatus 100 for setting up multi-tenant SaaS applications receives setup information required to set up the environments of SaaS applications from a tenant manager, and sets up SaaS applications in conformity with the environments of relevant tenants. In this case, the apparatus 100 for setting up multi-tenant SaaS applications sets up applications via the web. The apparatus 100 for setting up multi-tenant SaaS applications provides a service in which relevant settings are reflected without performing recompiling or re-executing a system after the setup of the environments of SaaS applications has been completed. For this operation, as shown in FIG. 1, the apparatus 100 for setting up multi-tenant SaaS applications includes an environment setup unit 120, a setup information management unit 140, a setup information storage unit 160, and a service provision unit 180.

The environment setup unit 120 receives setup information required to set up the environments of SaaS applications for respective tenants in SaaS application service environment. That is, the environment setup unit 120 receives the setup information for SaaS applications from the tenant manger in order to provide the respective tenants with applications suitable for the environments of the tenants. Here, the environment setup unit 120 receives setup information required to set up the environments of SaaS applications over the web. For example, the environment setup unit 120 provides a User Interface (UI) for setting up the environments of the SaaS applications to the terminal of the tenant manager on a UI component basis over the web. In this case, a UI component is a basic unit for performing functionality on the UI, for example, a panel, a form, a grid, a button, a combo-box, a radio button, or a list. The tenant manager selects a relevant UI component using the terminal and sets up the environment of a page (that is, for SaaS application). The tenant manager may set component-related attribute information, such as the location and color of the arranged UI component and the link of the UI component to a DB, via the attribute window of the UI component.

The environment setup unit 120 converts the setup information input from the tenant manager into metadata, and transmits the metadata to the setup information management unit 140. That is, the environment setup unit 120 converts the input setup information into a tree model, detects from the tree model only data corresponding to the characteristics of a relevant tenant, and then converts the setup information into the metadata. For example, the environment setup unit 120 manages the set page using the tree model, and maps each node of the tree model to a corresponding UI component. In this case, the environment setup unit 120 maps a URL for a page request to the root node of the tree model. The tenant manager completes the setup procedure, and thereafter stores the page. Accordingly, the environment setup unit 120 converts the page of the tree model into metadata. In this case, the fact that the environment setup unit 120 converts the tree model into the metadata means that only data corresponding to the characteristics of the tenant is detected rather than storing the data of the tree model without change. That is, since SaaS application is characterized in that a single instance supports multiple tenants, the tenants must share resources. Therefore, the environment setup unit 120 detects only data corresponding to tenant characteristics, which are not shared among the tenants, and then generates metadata from the detected data.

For example, the apparatus 100 for setting up multi-tenant SaaS applications uses the original page, implemented by the SaaS application, in unchanged form if the tenant manager uses a service without having made any settings related to pages. However, if a specific tenant manager sets up a page (that is, for the SaaS application) in conformity with the environment of his or her company using the environment setup unit 120, the users of the specific tenant use the page set by the tenant manager rather than the original page of the SaaS application. That is, in the case where one SaaS application instance services 100 tenants, if about 30 tenants use the service page of the application in unchanged form, and the remaining 70 tenants set up pages in conformity with their environments and are then using the set pages, information about the pages set by the 70 tenants is managed as metadata.

For this operation, as shown in FIG. 2, the environment setup unit 120 includes an input unit 122 for receiving setup information required to set up the environments of SaaS applications that are provided to the tenants, and a conversion unit 124 for converting the received setup information into a tree model, detecting from the tree model only data corresponding to the characteristics of a relevant tenant, and then converting the setup information into metadata.

The setup information management unit 140 stores the metadata converted by the environment setup unit 120 (that is, the metadata corresponding to the setup information) in the setup information storage unit 160. In this case, the setup information management unit 140 stores the tenant information and the metadata in the setup information storage unit 160 so that the tenant information is associated with the metadata, and then manages the setup information for the SaaS applications of a plurality of tenants.

The setup information storage unit 160 stores the metadata required to set up the environments of SaaS applications. That is, the setup information storage unit 160 stores therein metadata corresponding to the characteristics of each tenant and corresponding tenant information so that the metadata is associated with the tenant information.

The service provision unit 180 provides the SaaS applications, the environments of which have been set up for respective tenants using the stored metadata. That is, if a service request has been received from a tenant user, the service provision unit 180 detects metadata associated with a relevant tenant (or relevant tenant information). The service provision unit 180 dynamically generates a service (that is, SaaS application) using the detected metadata, and provides the generated service to the relevant tenant user.

In this way, the service provision unit 180 generates and provides SaaS applications that are dynamically implemented in conformity with the environments of respective tenants rather than providing statically implemented SaaS applications (that is, a web page, service logic, a data schema, etc.). Accordingly, the apparatus 100 for setting up multi-tenant SaaS applications is advantageous in that it can service the SaaS applications in real time by reflecting the setup information of the tenants without interrupting a relevant service, and can provide different environments to respective tenants. That is, the apparatus 100 for setting up multi-tenant SaaS applications according to the embodiment of the present invention can solve the problems of conventional SaaS where it makes it impossible for differentiated services to be provided to respective tenants because, except for simple UI settings, application code must be recompiled and executed after the application code itself have been revised, and all tenants are inevitably provided with the same service when they are provided with services by a single instance.

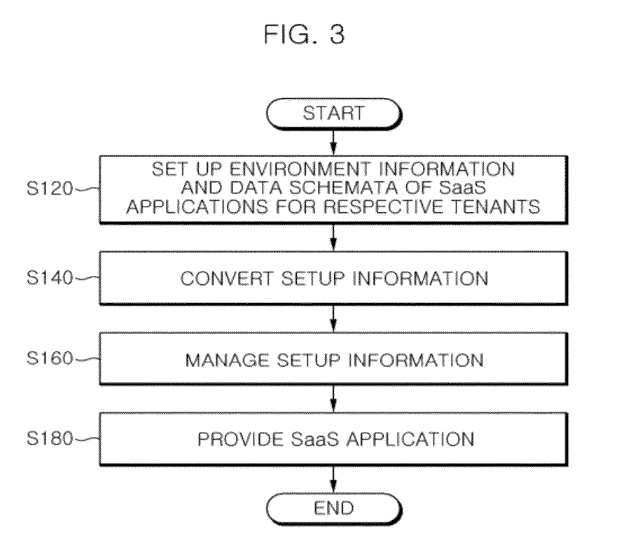

Hereinafter, a method of setting up multi-tenant SaaS applications according to a first embodiment of the present invention will be described in detail with reference to the attached drawings. FIG. 3 is a flowchart showing a method of setting up multi-tenant SaaS applications according to a first embodiment of the present invention.

First, the environment setup unit 120 sets up the environment information and data schema of SaaS applications on the basis of setup information input from a tenant manager at step S120. That is, the environment setup unit 120 receives setup information required to set up the environments of SaaS applications from the tenant manager. In this case, the environment setup unit 120 receives the setup information required to set up the environments of the SaaS applications over the web. For example, the environment setup unit 120 provides a UI for setting up the environments of the SaaS applications on a UI component basis to the terminal of the tenant manger. The tenant manager selects a UI component using the terminal and then sets up the environment of a page (that is, for SaaS application). The tenant manager may set component-related attribute information, such as the location and color of a relevant UI component and the link of the UI component to a DB, via the attribute window of the UI component.

The environment setup unit 120 converts the setup information input from the tenant manager into metadata at step S140. That is, the environment setup unit 120 converts the setup information input from the tenant manager into metadata, and transmits the metadata to the setup information management unit 140. In this case, the environment setup unit 120 converts the input setup information into a tree model, detects from the tree model only data corresponding to the characteristics of a relevant tenant, and then converts the setup information into the metadata. In this case, the environment setup unit 120 detects only the data corresponding to tenant characteristics which are not shared among tenants, and then generates the metadata.

The setup information management unit 140 manages the metadata converted by the environment setup unit 120 at step S160. That is, the setup information management unit 140 stores the metadata converted by the environment setup unit 120 (that is, the metadata corresponding to the setup information) in the setup information storage unit 160. In this case, the setup information management unit 140 stores tenant information and the metadata in the setup information storage unit 160 so that the tenant information is associated with the metadata, thus managing the setup information for the SaaS applications of a plurality of tenants. Accordingly, the setup information storage unit 160 stores therein metadata, corresponding to the characteristics of each tenant, and relevant tenant information so that the metadata is associated with the tenant information.

The service provision unit 180 dynamically generates SaaS application using the metadata of a relevant tenant at the request of a tenant user, and provides the generated SaaS application to the tenant user at step S180. The service provision unit 180 detects metadata associated with the relevant tenant (or relevant tenant information) if a service request is received from the tenant user. The service provision unit 180 dynamically generates a service (that is, SaaS application) using the detected metadata, and provides the relevant tenant user with the service. That is, the service provision unit 180 provides SaaS applications that have been set up in different environments for respective tenants using the stored metadata.

In this way, the present invention is advantageous in that setup information for SaaS applications is converted into metadata and the metadata is managed and in that when there is a request from a tenant, a relevant service is dynamically generated and provided based on the metadata, thus enabling independent applications to be set for respective tenants.

Further, in the present invention, a tenant that uses SaaS application service can reflect business requirements in applications in conformity with the situation of the tenant without re-executing the service. That is, a user interface and a data schema can be set in accordance with the environment of the tenant. Accordingly, the present invention facilitates both helping the service provided by the SaaS application to be optimized for the environment of the tenant and setting up the service, thus obtaining the effect of reducing costs required by tenants to use the service.

Furthermore, in the present invention, since services are generated and provided based on metadata, independent service environments can be provided to the respective tenants. This allows SaaS application vendors to considerably reduce maintenance costs. Existing web applications are problematic in that when updating the service, all applications that provide the service must be updated. However, SaaS applications are advantageous in that since the service is independently provided to all tenants by one instance, all tenants can be provided with updated service using a single update operation, and tenant-independent service environments can be equally used similarly to the conventional technology.

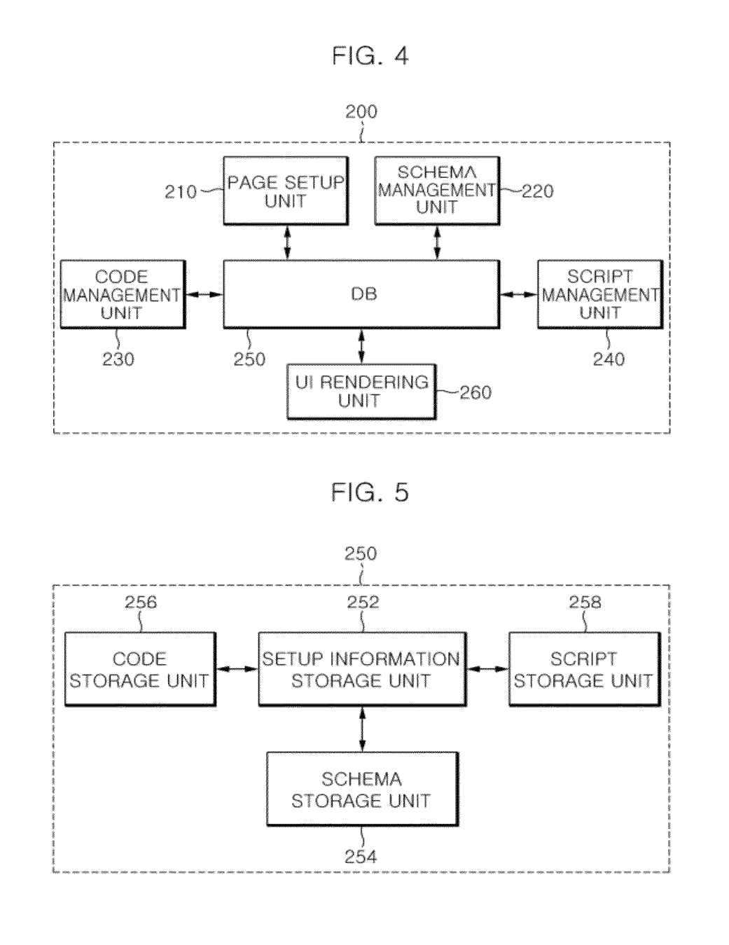

Hereinafter, an apparatus for setting up multi-tenant SaaS applications according to a second embodiment of the present invention will be described in detail with reference to the attached drawings. FIG. 4 is a block diagram showing the construction of an apparatus for setting up multi-tenant SaaS applications according to a second embodiment of the present invention. FIG. 5 is a block diagram showing the construction of the DB of FIG. 4. First, in the second embodiment of the present invention, the scope of setup is described as being limited to the setup of a user interface and the setup of a data schema.

As shown in FIG. 4, an apparatus 200 for setting up multi-tenant SaaS applications includes a page setup unit 210, a schema management unit 220, a code management unit 230, a script management unit 240, a domain management unit, a DB 250, and a UI rendering unit 260.

The page setup unit 210 performs a function related to the setup of a user interface. That is, the page setup unit 210 receives setup information for SaaS application (that is, a page) shown to a tenant user, and sets and manages the user interface of a relevant tenant.

The page setup unit 210 receives setup information required to set up the environment of the page from a tenant manager. That is, the page setup unit 210 outputs a web page required to set up the environment of the page via the terminal of the tenant manager, and then requests the tenant manager to input setup information. In this case, the page setup unit 210 provides the tenant manager with the function of setting up the page on a UI component basis. In this case, the page setup unit 210 may receive component-related attribute information, such as the location and color of a relevant UI component and the link of the UI component to the DB 250, from the tenant manager via the attribute window of the UI component.

The page setup unit 210 manages the setup information of the page using a tree-structured data model. That is, the page setup unit 210 manages the UI component, which has been input from the tenant manager to set up the environment of the page, in the form of a tree. In this case, the page setup unit 210 manages the tree-structured data model including the attribute information of each UI component.

The page setup unit 210 converts the setup information of the page into metadata and stores the metadata in the DB 250. In detail, when a request for the storage of the page (that is, the completion of the input of the setup information) is received from the tenant manager, the page setup unit 210 converts the set page into metadata and stores the metadata in the setup information storage unit 252 of the DB 250. Here, the fact that the page is converted into metadata means that only the data corresponding to the characteristics of the relevant tenant is detected from the tree-structured data model managed by the page setup unit 210.

The schema management unit 220 performs a function related to the setup of the data schema of SaaS application used by the tenant. That is, the schema management unit 220 is used when the schema information of the SaaS application is intended to be handled using a user's web page. For example, when the user desires to add a column to a table displayed on a web page, the column added to the UI must be linked to an actual application table. In this case, the schema management unit 220 supports a link between the column on the UI and the column on the table of the SaaS application.

The code management unit 230 manages codes that are used on SaaS application used by each tenant user. In this case, the code management unit 230 manages codes that are used to define an input form or the data type of a table.

The script management unit 240 supports a data validity check, a rendering script, etc. using the user's web page.

The domain management unit manages domain information about data. That is, the domain management unit manages script-type domain information and code-type domain information. For example, when a column is randomly added to a table, a domain can be defined. In this case, the defined domain includes a specific script type or code type, and thus the data type of the table column can be defined by selecting one from among the script type and the code type.

The DB 250 stores data related to the setup of each SaaS application. In this case, the DB 250 stores data related to the setup of the SaaS application so that the data is associated with tenant information. Here, the DB 250 stores setup information required to set up the environment of a page on the SaaS application, the schema information of the SaaS application, and data including the code, script, etc. that are used by the SaaS application.

For this operation, as shown in FIG. 5, the DB 250 includes a setup information storage unit 252 for storing setup information required to set up the environment of each page, a schema storage unit 254 for storing schema information, a code storage unit 256 for storing codes, and a script information storage unit 258 for storing scripts.

In the present embodiment, although the setup information storage unit 252, the schema storage unit 254, the code information storage unit 256, and the script storage unit 258 have been described as being implemented as a single DB, the present invention is not limited to this embodiment and those units may be implemented as individual DBs.

The UI rendering unit 260 dynamically generates SaaS application using metadata and provides the SaaS application to a tenant user. That is, the UI rendering unit 260 detects metadata for a specific tenant from the DB 250 (that is, the setup information storage unit 252). The UI rendering unit 260 dynamically generates a user page using the detected metadata. The UI rendering unit 260 provides the generated user page to the tenant user over the terminal of the tenant user. Since the UI rendering unit 260 reads metadata for each tenant from the DB 250 in this way, an independent page can be generated and provided to each tenant.

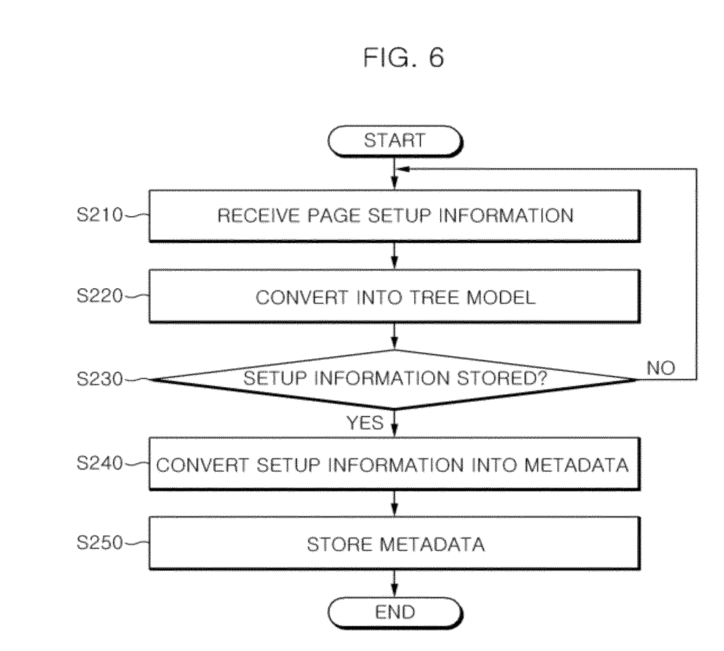

Hereinafter, a method of setting up the environments of SaaS applications using page setup in the method of setting up multi-tenant SaaS applications according to the second embodiment of the present invention will be described in detail with reference to the attached drawings. FIG. 6 is a flowchart showing a method of setting up the environments of SaaS applications using page setup according to the second embodiment of the present invention.

First, the page setup unit 210 receives setup information required to set up the page of SaaS application from a tenant manager at step S210. That is, the page setup unit 210 outputs a web page required to set up the environment of a page on the terminal of the tenant manager and then requests the tenant manager to input setup information. In this case, the page setup unit 210 provides the function of setting up pages on a UI component basis to the tenant manager. In this case, the page setup unit 210 may also receive component-related attribute information, such as the location and color of a relevant UI component and the link of the UI component to the DB 250, from the tenant manager via the attribute window of the UI component.

The page setup unit 210 converts the input page setup information into a tree model at step S220. That is, the page setup unit 210 manages the UI component input from the tenant manager to set up the environment of a page in the form of a tree. In this case, the page setup unit 210 manages a tree-structured data model including the attribute information of each UI component. In this case, the page setup unit 210 maps each node of the tree model to a corresponding UI component. The page setup unit 210 maps the root node of the tree model to a component which stores a Uniform Resource Locator (URL) for a page request.

When the tenant manager completes the setup and stores the relevant page (in the case of YES) at step S230, the page setup unit 210 converts the page setup information into metadata at step S240. That is, when a request for the storage of the page (that is, the completion of the input of the setup information) is received from the tenant manager, the page setup unit 210 converts the set page into metadata. Here, the fact that the page is converted into metadata means that only the data corresponding to the characteristics of the relevant tenant is detected from the tree-structured data model managed by the page setup unit 210 rather than storing the data of the tree model without change. The reason for this is that tenants must share resources because a single instance must support multiple tenants depending on the characteristics of the SaaS application. For example, if the tenant manager uses a service without having made any settings related to pages, the apparatus 200 for setting up multi-tenant SaaS applications provides the original page, implemented by the SaaS application, in unchanged form. However, if a specific tenant manager sets up a page in conformity with the environment of his or her company, the apparatus 200 for setting up multi-tenant SaaS applications provides the users of the specific tenant with the page set by the tenant manager rather than the original page of the SaaS application.

The page setup unit 210 stores the converted metadata in the DB 250 at step S250. In this case, the page setup unit 210 stores the metadata and the tenant information so that the metadata is associated with the tenant information. The page setup unit 210 stores only the metadata for the tenant which has performed the page setup. For example, if it is assumed that the apparatus 200 for setting up multi-tenant SaaS applications services one SaaS application to 100 tenants, 30 tenants uses the service page of the application without change, and the remaining 70 tenants set the page in conformity with the environment of each tenant and use the set page, the page setup unit 210 converts page information set by the 70 tenants into metadata, and stores and manages the metadata in the setup information storage unit 252.

In this case, the DB 250 separately manages a storage unit for managing metadata (that is, the setup information storage unit 252) and a storage unit for managing SaaS application data (that is, the code information storage unit 256, the script storage unit 258, and the schema storage unit 254). That is, the page setup unit 210 stores the metadata, converted by converting the setup information required for page setup, in the setup information storage unit 252, thus enabling the metadata to be stored separately from the SaaS application data such as code data and script data.

Thereafter, the UI rendering unit 260 dynamically generates SaaS application using the metadata, and provides the generated SaaS application to the tenant user. That is, the UI rendering unit 260 detects metadata for the specific tenant from the DB 250 (that is, the setup information storage unit 252). The UI rendering unit 260 dynamically generates a user page using the detected metadata. The UI rendering unit 260 provides the generated user page to the tenant user over the terminal of the tenant user. Since the UI rendering unit 260 reads metadata for each tenant from the DB 250 in this way, each independent page can be generated and provided to a corresponding tenant. Therefore, the UI rendering unit 260 combines pieces of metadata for respective tenants in real time on the basis of the generation of existing pages, generates pages required by the tenants, and then provides the pages to the corresponding tenant users.

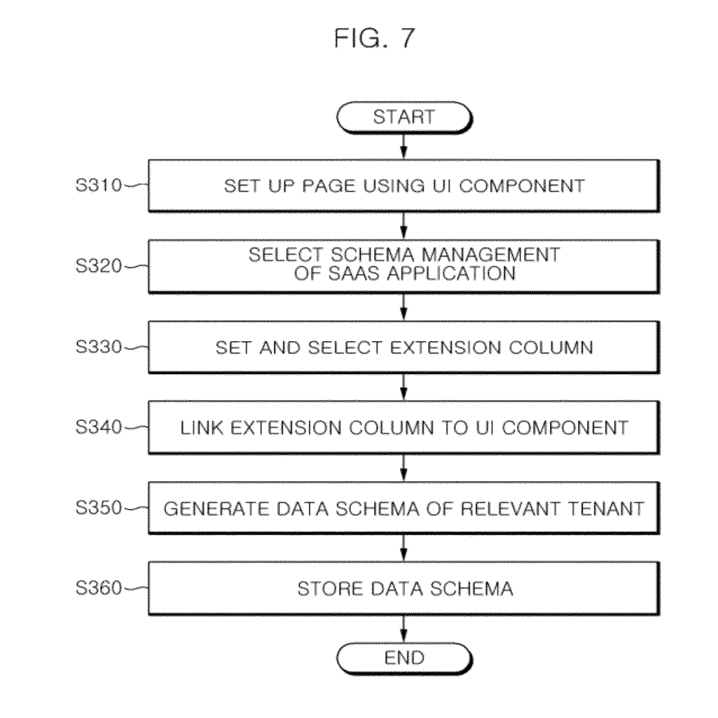

Hereinafter, a method of setting up the environments of SaaS applications using schema setup in the method of setting up multi-tenant SaaS applications according to the second embodiment of the present invention will be described in detail with reference to the attached drawings. FIG. 7 is a flowchart showing a method of setting up the environments of SaaS applications using data schema setup according to the second embodiment of the present invention.

The tenant manager can set up the schema of the DB 250 while setting up pages, using the apparatus 200 for setting up multi-tenant SaaS applications. In this case, the tenant manager can set up the schema of the DB 250 using a UI component, sets up a UI related to the DB 250, and thereafter must take into consideration the link of the UI to the DB 250. For example, when an input form is additionally generated and received as input and is then stored in the DB 250, or when the field of a table that was not previously present is added and then data is output, an operation of linking the UI component to the DB 250 while adding the UI component is required. Hereinafter, a method of setting up the environments of SaaS applications using data schema setup, for example, by adding a column will be described.

First, the page setup unit 210 receives setup information required for page setup using a UI component from a tenant manager and sets up the page of SaaS application at step S310. In this case, the tenant manager adds a table column component to a relevant page if an extension column (field) to be added to an existing page is present. For example, if a table column to be added to the existing page is present, the table column component is added to the page. Accordingly, the page setup unit 210 adds the additional table column component to the page, and then generates the current page. In this case, the additional table column generated by the page setup unit 210 is in a state in which it is not yet linked to the DB 250. Therefore, when the page is stored in the current step and then the use of the page is requested, no data is present in the added table column.

The tenant manager selects the schema management of the SaaS application so as to link the table of the DB 250 to the added table column at step S320. For example, in order to link the table column, added to the page generated at step S310, to the DB 250, the tenant manager selects a menu for the schema management of the SaaS application.

The tenant manager selects the table of the DB 250 linked to the added table column and establishes a link between the table column and the DB 250 at step S330. This operation will be described in detail below.

First, the schema management unit 220 displays the tables of the DB 250 that can be linked to table columns. In this case, the schema management unit 220 displays information about fixed table columns that are currently being serviced. Of course, the schema management unit 220 can also check information about extension columns that are not yet being used. Here, extension columns refer to columns included in all tables within the SaaS application, and denote columns allocated in advance for use by each tenant. Therefore, the tenant manager can set and use columns in compliance with the requirements of each tenant using such extension columns.

The tenant manager selects a table to be linked to an extension column from the tables of the DB 250 displayed by the schema management unit 220, and links the extension column to the DB 250. Accordingly, the schema management unit 220 links the extension column selected and set by the tenant manager to the UI component on the page at step S340. In this case, the schema management unit 220 can set the data type, validity check, etc. of the extension column linked to the UI component. In this regard, the schema management unit 220 can set the attribute of the extension column using functions such as script management, domain management, and code management. The page setup unit 210 converts the page including the UI component linked to the extension column for the relevant tenant into metadata, and stores the metadata in the DB 250.

The schema management unit 220 generates a data schema for the relevant tenant at step S350, and stores the generated data schema in the DB 250 at step S360.

As described above, the present invention is advantageous in that setup information for SaaS applications is converted into metadata and the metadata is managed and in that when there is a request from a tenant, a relevant service is dynamically generated and provided based on the metadata, thus enabling independent applications to be set for respective tenants.

Further, in the present invention, a tenant that uses SaaS application service can reflect business requirements in applications in conformity with the situation of the tenant without re-executing the service. That is, a user interface and a data schema can be set in accordance with the environment of the tenant. Accordingly, the present invention facilitates both helping the service provided by the SaaS application to be optimized for the environment of the tenant and setting up the service, thus obtaining the effect of reducing costs required by tenants to use the service.

Furthermore, in the present invention, since services are generated and provided based on metadata, independent service environments can be provided to the respective tenants. This allows SaaS application vendors to considerably reduce maintenance costs. Existing web applications are problematic in that when updating the service, all applications that provide the service must be updated. However, SaaS applications are advantageous in that since the service is independently provided to all tenants by one instance, all tenants can be provided with updated service using a single update operation, and tenant-independent service environments can be equally used similarly to the conventional technology.

Although preferred embodiments of the present invention have been described, it should be understood that the present invention can be modified in various manners and those skilled in the art can implement various modifications and changes without departing from the scope of the claims of the present invention.

What is claimed is:

1. An apparatus for setting up multi-tenant Software as a Service (SaaS) applications, comprising:
an environment setup unit for receiving setup information required to set up service environments of SaaS applications and converting the setup information into metadata;
a setup information management unit for managing setup information of SaaS applications for respective tenants using the metadata converted by the environment setup unit; and
a service provision unit for providing SaaS applications that have been set up in different environments for the respective tenants using the metadata.

2. The apparatus of claim 1, wherein the environment setup unit comprises:
an input unit for receiving the setup information required to set up the environments of the SaaS applications; and
a conversion unit for converting the setup information into the metadata.

3. The apparatus of claim 1, wherein the environment setup unit converts the setup information into a tree model, detects only data corresponding to characteristics of a relevant tenant from the tree model, and then converts the setup information into the metadata.

4. The apparatus of claim 1, wherein the setup information management unit manages the metadata converted by the environment setup unit so that the metadata is associated with relevant tenants.

5. The apparatus of claim 1, further comprising a setup information storage unit for storing setup information of a plurality of tenants.

6. The apparatus of claim 5, wherein the setup information storage unit stores tenant information and the metadata so that the tenant information is associated with the metadata.

7. An apparatus for setting up multi-tenant Software as a Service (SaaS) applications, comprising:
a page setup unit for converting setup information that is input to set up user interfaces for respective tenants of SaaS applications into metadata;
a database (DB) for storing the metadata converted by the page setup unit so that the metadata is associated with information about relevant tenants; and
a User Interface (UI) rendering unit for dynamically generating SaaS application using metadata for a tenant detected from the DB, and providing the SaaS application to a user of the tenant.

8. The apparatus of claim 7, wherein the page setup unit receives the setup information required to set up the user interfaces by a UI component unit.

9. The apparatus of claim 7, wherein the page setup unit converts the setup information into a tree model, manages the tree model, and if setup of the user interfaces has been completed, converts the tree model into metadata and stores the metadata in the DB.

10. The apparatus of claim 9, wherein the page setup unit detects only data corresponding to characteristics of a relevant tenant from the tree model, and then converts the setup information into the metadata.

11. The apparatus of claim 7, wherein the DB further stores at least one of data schema information, code information, and script information which are used by each SaaS application.

12. The apparatus of claim 7, further comprising a schema management unit for managing, for respective tenants, schema information required to set up data schema used by SaaS applications.

13. The apparatus of claim 12, wherein the schema management unit links a UI component used by the SaaS application to a table of the DB.

14. The apparatus of claim 7, further comprising a code management unit for managing a plurality of code used by the SaaS application that is provided to the tenant user.

15. The apparatus of claim 7, further comprising a script management unit for managing script information that comprises at least one of a data validity check and a rendering script of SaaS application provided in a form of a web page.

16. The apparatus of claim 7, further comprising a domain management unit for managing script-type domain information and code-type domain information.

17. A method for setting up multi-tenant Software as a Service (SaaS) applications, comprising:
setting setup information including at least one of environment information, required to set up environments of SaaS applications for respective tenants, and data schema;
converting the setup information of the SaaS applications for respective tenants into metadata;
managing the metadata so that the metadata is associated with information about relevant tenants; and
providing a tenant user with SaaS application that is generated using metadata for a tenant, for which use of SaaS application has been requested, in the metadata.

18. The method of claim 17, wherein the converting comprises:
converting the setup information into a tree model; and
converting the tree model into the metadata.

19. The method of claim 18, wherein the converting into the metadata is configured to detect only data corresponding to characteristics of a relevant tenant from the tree model and then convert the setup information into the metadata.

20. The method of claim 17, further comprising setting up data schema used by SaaS applications for respective tenants.
